(19) United States
(12) Patent Application Publication
(10) Pub. No.: US 2026/0236378 A1
(43) Pub. Date: Aug. 13, 2026

(54) SOFTWARE VERIFICATION APPARATUS AND SOFTWARE VERIFICATION METHOD

(71) Applicant: HITACHI, LTD., Tokyo (JP)

(72) Inventors: Yasufumi Suzuki, Tokyo (JP); Masumi Kawakami, Tokyo (JP)

(73) Assignee: HITACHI, LTD., Tokyo (JP)

(21) Appl. No.: 19/156,630

(22) PCT Filed: Feb. 13, 2024
(86) PCT No.: PCT/JP2024/004807

§ 371 Date: Aug. 14, 2025

(30) Foreign Application Priority Data
Mar. 14, 2023 (JP) 2023-039456

(51) Int. Cl. G06F 11/3668

(52) U.S. Cl. CPC G06F 11/3684

(57) ABSTRACT

A software verification apparatus includes a specification covering test case generation part configured to generate a test case that covers a combination of factors extracted from specification information regarding software given as a test target, a test execution part configured to execute testing of the software by using the generated test case to generate code coverage information regarding the software in the executed test case, and an additional test case generation part configured to, based on a relation between a factor or a level thereof in the test case generated by the specification covering test case generation part and the generated code coverage information, generate an additional test case that makes a code coverage higher than the test case related to the code coverage information.

### TECHNICAL FIELD

The present invention relates to a software verification apparatus and a software verification method.

### BACKGROUND ART

### Incorporation by Reference

This application is based upon and claims the benefit of priority from Japanese Patent Application No. 2023-039456, filed on Mar. 14, 2023, the entire contents of which are incorporated herein by reference.

In order to detect defects in software and improve its quality, it is necessary to execute testing of the software for verification. With increasing numbers of test cases of the software, however, longer time periods and more calculation resources are required to execute the testing. It is thus preferred that a minimum number of test cases be prepared to detect the defects efficiently. The problem is that for software developers to design and implement such efficient test cases requires managing a large amount of workload. In order to solve this and other problems, there have been disclosed technologies that automatically generate test cases for software verification.

Non Patent Document 1 discloses techniques that generate test cases automatically with use of the Pairwise method (referred to as “Covering Array” in Non Patent Document 1) from the interface specification information described by use of OpenAPI, which is a specification and description language of API (Application Programming Interface). Non Patent Document 1 discloses that the Pairwise method is used to generate test cases efficiently covering combinations of Web API parameters defined in the interface specification information.

Patent Document 1 discloses techniques for extracting branch conditions from activity diagrams of UML (Uniformed Modeling Language) to generate test cases covering the branches involved. Patent Document 1 discloses the generation of test cases which, when executed, increase code coverage indicating which paths have been taken in source code.

### Prior Art Document

### Patent Document

Patent Document 1: PCT Patent Publication No. WO2016/170937

### Non Patent Document

Non Patent Document 1: Huayao Wu, Lixin Xu, Changhai Nie, “Combinatorial testing of RESTful APIs,” Proceedings of 44th International Conference on Software Engineering, May 2022, pp. 426-437.

### SUMMARY OF THE INVENTION

### Problems to be Solved by the Invention

The quality of software is evaluated from two perspectives: from a viewpoint of specification coverage, i.e., how many software specification combinations have been covered through the testing, and from a viewpoint of code coverage, i.e., what percentage of pieces of code in source code has been executed.

One problem with the above-cited techniques is that it is impossible to automatically generate test cases that efficiently satisfy both specification coverage and code coverage. For example, the techniques disclosed in Non Patent Document 1 do not take into consideration code coverage in generating test cases and are thus incapable of generating those test cases that would efficiently increase code coverage.

Further, the techniques disclosed in Patent Document 1 require creating a UML activity diagram describing the branch conditions in the source code. The problem is that only the developers with a deep understanding of the content of the source code can create that activity diagram.

The present invention has been made in view of the above circumstances. An object of the invention is therefore to provide a software verification apparatus and a software verification method capable of automatically generating test cases that extensively cover software specifications while providing high code coverage.

### Means for Solving the Problems

In solving the foregoing problems and according to one embodiment of the present invention, there is provided a software verification apparatus including a processor, a memory, a specification covering test case generation part configured to generate a test case that covers a combination of factors extracted from specification information regarding software given as a test target, a test execution part configured to execute testing of the software by using the generated test case to generate code coverage information regarding the software in the executed test case, and an additional test case generation part configured to, based on a relation between a corresponding one of the factors or a level thereof in the test case generated by the specification covering test case generation part and the generated code coverage information, generate an additional test case that makes a code coverage higher than the test case related to the code coverage information.

### Advantages of the Invention

The present invention thus makes it possible to automatically generate the test cases that extensively cover software specifications while providing high code coverage.

The foregoing and other objects, structures, and advantages of the present invention will become evident from a reading of the following detailed description of preferred embodiments.

### BRIEF DESCRIPTION OF THE DRAWINGS

FIG. 1 is a view depicting an exemplary configuration of a software verification apparatus as a first embodiment of the present invention.

FIG. 2 is a view depicting exemplary interface specification information.

FIG. 3 is a view depicting an exemplary test case.

FIG. 4 is a view depicting exemplary code coverage information.

FIG. 5 is a view explaining a flow of processing performed by the software verification apparatus as the first embodiment of the present invention.

FIG. 6 is a view depicting an exemplary functional configuration of a software verification apparatus as a second embodiment of the present invention.

FIG. 7 is a view listing exemplary Pairwise generation parameters.

FIG. 8 is a view explaining an outline of processing performed by the software verification apparatus.

FIG. 9 is a flowchart explaining an overall flow of processing performed by the software verification apparatus.

FIG. 10 is a process flowchart explaining an exemplary parameter updating process performed by a coverage learning part.

FIG. 11 is a process flowchart explaining another exemplary parameter updating process performed by the coverage learning part.

FIG. 12 is a view depicting an exemplary test result display screen generated by a test result display part.

### MODES FOR CARRYING OUT THE INVENTION

Some preferred embodiments of the present invention are described below in detail with reference to the accompanying drawings. The ensuing description and the drawings are examples intended to explain the present invention and may thus be simplified or abbreviated as needed for purposes of clarification. The present invention may be implemented in various other embodiments. Unless specifically noted, each of the components involved may be singular or plural.

The positions, sizes, shapes, and ranges of the components indicated in the drawings may not represent their actual positions, sizes, shapes, and ranges for the purpose of facilitating the understanding of the present invention. It is hence to be noted that the positions, sizes, shapes, and ranges disclosed in the drawings are not necessarily limitative of the present invention.

In the description that follows, various kinds of information may be explained using the expressions “table,” “list,” and “queue,” for example. However, such information may alternatively be expressed using data structures other than the tables, lists, or queues. The expression “XXX table” or “XXX list” may alternatively be referred to as “XXX information” in order to indicate that the information is not dependent on the data structures. In the case where identification information is explained using such expressions as “identification information,” “identifier,” “ID,” and “number,” these expressions are interchangeable.

In the case where there are multiple components having the same or similar functions, these components may be explained using the same reference symbols with different suffixes. However, if there is no need to distinguish these components, they may be explained without recourse to such suffixes.

In the description that follows, there are cases of explaining processes performed by execution of programs.

The programs are executed by a processor (e. g., CPU, GPU) in such a manner that predetermined processes are carried out using storage resources (e.g., memory) and/or an interface device (e. g., communication port) as needed. In that sense, the agent of the processing may be considered the processor. Likewise, the agent of the processing performed by program execution may be a controller, an apparatus, a system, a computer, or a node having the processor. The agent of the processing performed by executing the program may be an arithmetic part that may include a dedicated circuit for carrying out specific processes (e.g., FPGA or ASIC).

The programs may be installed into an apparatus such as a computer from program sources. The program source, for example, may be a program distribution server or a computer-readable storage medium. In a case where the program source is a program distribution server, the program distribution server may include a processor and storage resources for storing the programs targeted for distribution. The processor of the program distribution server may distribute the distribution target programs to other computers. In the ensuing description, two or more programs may be implemented as one program, and one program may be implemented as two or more programs.

### First Embodiment

Explained first are a software verification apparatus and a software verification method practiced as a first embodiment of the present invention.

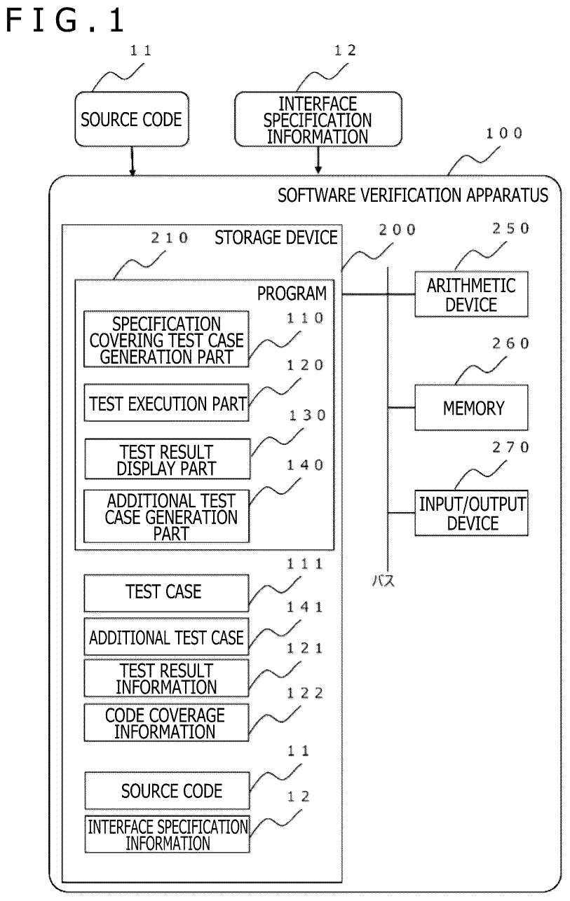

FIG. 1 is a view depicting an exemplary configuration of a software verification apparatus 100 as the first embodiment of the present invention. The software verification apparatus 100 is implemented by an information processing apparatus configured with one or multiple computers. Besides implementing a user interface of its own, the software verification apparatus 100 may alternatively utilize as the user interface a user terminal connected via a suitable network. In this case, the user terminal is a terminal apparatus operated by software developers or testers. Specifically, the user terminal may be a personal computer, a smartphone, or a tablet terminal.

The software verification apparatus 100 is an information processing apparatus placed in a test environment of the software targeted for verification by testing (referred to as “target software” hereunder). The software verification apparatus 100 automatically generates efficient test cases needed to execute testing of the target software, and outputs the result of the testing carried out on the basis of the generated test cases.

As depicted, the software verification apparatus 100 includes a storage device 200, an arithmetic device 250, a memory 260, and an input/output device 270. The storage device 200, the arithmetic device 250, the memory 260, and the input/output device 270 are communicably interconnected via a bus.

The arithmetic device 250 is a CPU (Central Processing Unit) that performs overall control on the entire apparatus by loading a program 210 held by the storage device 200 into the memory 260 for execution, for example, and carries out various determinations, calculations, and control processes.

The memory 260 is configured by a volatile storage element such as a RAM (Random Access Memory) or a ROM (Read Only Memory).

The input/output device 270 is a device that receives key input or audio input from a user and displays processed data. For example, the input/output device 270 is constituted by an input device such as a keyboard, a mouse, a touch panel, and a microphone, a display device such as a liquid crystal display (LCD) or an organic EL (Electro-Luminescence) display, or a printout device such as a printer. The input/output device 270 may include a network interface card that performs communication processing with the user terminal when connected thereto over a suitable network.

The storage device 200 is configured by a suitable nonvolatile storage element such as an SSD (Solid State Drive) or a hard disk drive. In addition to the program 210 implementing various functions required of the software verification apparatus 100 of the present invention, the storage device 200 stores at least source code 11 of the target software, interface specification information 12, test cases 111 to be discussed later, test result information 121 to be discussed later, code coverage information 122 to be discussed later, and additional test cases 141 to be discussed later.

The input to the software verification apparatus 100 includes the source code 11 of the target software and the interface specification information 12. The interface specification information 12 is specification information including information necessary for generating factors and levels (factor values) used for testing the target software. The factors refer to the types of parameters and elements targeted for software testing. The levels refer to the values or their representative values allowed to be input to the factors.

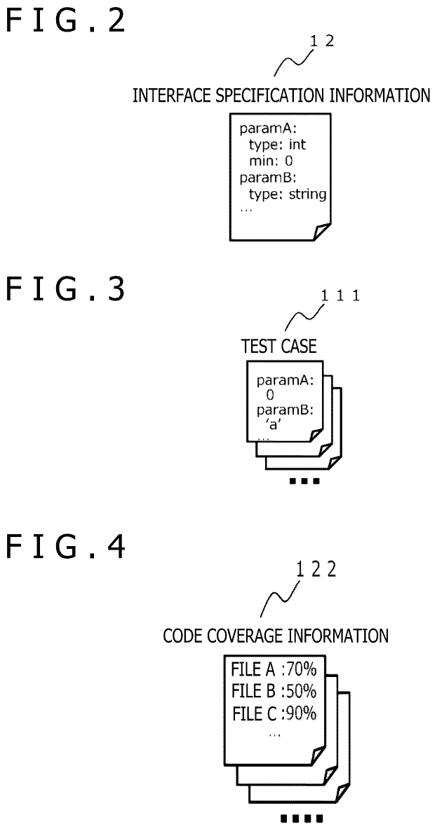

FIG. 2 is a view depicting an example of the interface specification information 12. The exemplary interface specification information 12 in the illustration includes parameters given as factors (“ParamA” and “ParamB”), the types of the parameters, the ranges of the values that can be taken by each of the parameters, and the numbers of parameters. For example, the parameter “ParamA” is of int type and takes a value of at least 0.

For example, in the case of a web service, a specification description based on the openAPI specification description may be used as the interface specification information 12. The techniques disclosed in Non Patent Document 1 may be used to generate the factors and levels from the OpenAPI specification description.

Next, as indicated in FIG. 1, the program 210 includes programs for implementing a specification covering test case generation part 110, a test execution part 120, a test result display part 130, and an additional test case generation part 140.

On the basis of the interface specification information 12, the specification covering test case generation part 110 executes a specification covering test case generation process for generating the test case 111 that covers the specification of the target software.

FIG. 3 is a view depicting an exemplary test case 111. In the test case 111 in the illustration, a level “0” is set for the factor “ParamA,” and a level “a” is set for the factor “ParamB.”

The test execution part 120 executes a test execution process that performs testing of the target software by use of the source code 11 of the target software and the test case 111 generated by the specification covering test case generation part 110. In executing the testing, the test execution part 120 also acquires code coverage indicating which paths in the source code 11 have been executed by execution of testing. Thereafter, the test execution part 120 outputs information that includes the test result information 121 including information indicating whether the test case of interest has been successful and the code coverage information 122 regarding that test case.

The test result information 121 includes such information as whether each of the test cases 111 has succeeded (OK) or failed (NG), the number of successful test cases 111, and the number of failed test cases 111.

FIG. 4 is a view depicting exemplary code coverage information 122. The code coverage information 122 includes information regarding the code coverage of each of the files and each of the functions included in the files in the source code 11. The exemplary code coverage information 122 in the illustration includes code coverage of 70% for file A, code coverage of 50% for file B, and code coverage of 90% for file C. The code coverage refers to a percentage indicating how many pieces of the source code 11 have been tested. The code coverage may be measured by any one of diverse methods including instruction coverage, branch coverage, condition coverage, compound condition coverage, and path combination coverage.

The test result display part 130 displays details of the test result information 121 and the code coverage information 122 that are output by the test execution part 120, on a screen for verification by such users as developers. When the user uses a project management tool for managing the development status of a given project, the test result display part 130 may transmit the information to the project management tool.

The additional test case generation part 140 performs an additional test case generation process. This process involves generating an additional test case 141 that makes the code coverage higher than the test case 111 related to the code coverage information 122, by identifying the factor or the level contributing to increasing the code coverage, based on the relation between the factors or their levels in the test case 111 and the code coverage information 122 obtained by use of that test case 111.

Besides having its constituent functions placed in a single information processing apparatus, the software verification apparatus 100 may alternatively have its functions arranged in a distributed manner in multiple information processing apparatuses interconnected via networks or in calculation resources in a cloud.

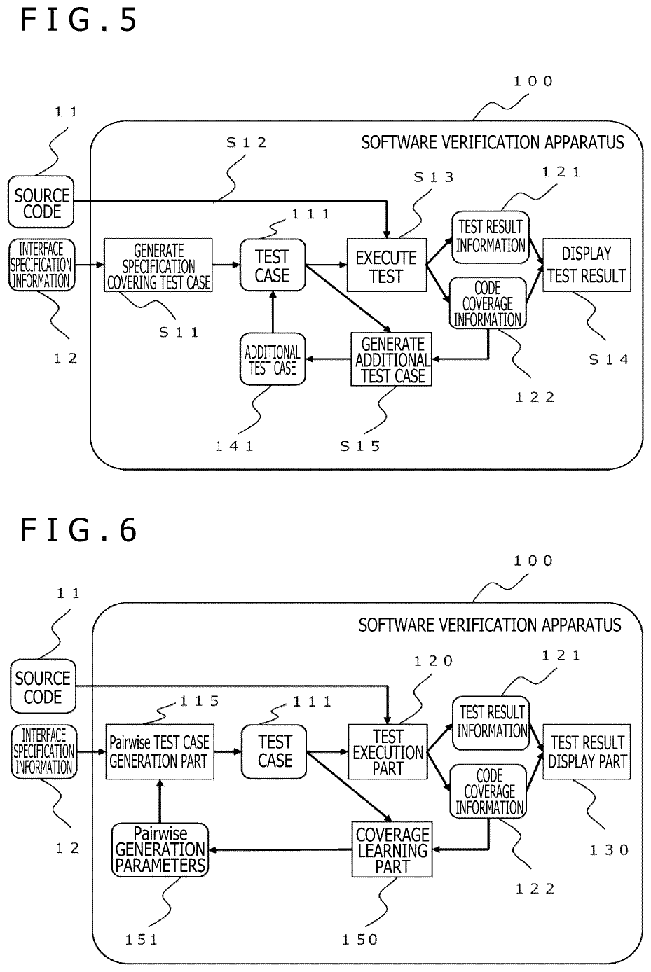

FIG. 5 is a view explaining a flow of processing performed by the software verification apparatus 100 as the first embodiment of the present invention. As depicted, the specification covering test case generation part 110 first generates such a test case 111 that covers the specification of the target software, on the basis of the interface specification information 12 (S11). This process is started, for example, when the user makes a predetermined input to the software verification apparatus 100 or at predetermined timings (e.g., at a predetermined point in time or at predetermined time intervals). For example, the specification covering test case generation part 110 may start this process when the user designates the interface specification information 12 regarding the target software and causes the software verification apparatus 100 to read the designated information.

For example, the specification covering test case generation part 110 may generate a test case that covers all combinations of the factors and levels defined in the interface specification information 12, or generate a test case by randomly generating a value for each of the factors. Known combinational testing techniques for generating test cases for effective combinational testing include a technique using an orthogonal table and a technique utilizing the Pairwise method (All-Pair method) to be discussed later. The specification covering test case generation part 110 may adopt any of these techniques in generating the test cases.

Next, the test execution part 120 acquires the source code 11 of the target software (S12). The test execution part 120 then executes testing of the target software using the test case 111 generated in S11 and the source code 11 of the target software acquired in S12 (S13). For example, the test execution part 120 sets the combination of the factors and levels of the test case 111 as the initial values in the source code 11, and executes the source code 11 in which these initial values are set.

In carrying out testing, the test execution part 120 also acquires the code coverage of the test case 111 of interest, and outputs the code coverage information 122 together with the test result information 121.

One method used by the test execution part 120 to obtain the code coverage involves executing the testing after carrying out program transformation in a manner inserting into the source code 11 pieces of code for causing output, to a log, of information indicating whether each of the lines in the source code 11 has been executed. The test execution part 120 may alternatively acquire the code coverage by use of the arithmetic device 250 having a function of obtaining execution location information regarding programs.

Next, the test result display part 130 displays details including the test result information 121 and the code coverage information 122 that are output by the test execution part 120, onto a screen (S14).

Meanwhile, the additional test case generation part 140 generates an additional test case 141 that further increases the code coverage, on the basis of a given test case 111 and the code coverage information 122 obtained by use of that test case 111 (S15). Besides using the technique of changing the generation parameters of the Pairwise method to be discussed later, the additional test case generation part 140 may alternatively generate an additional test case 141 for which the types of the levels for the factors contributing to increasing the code coverage are increased or in which the level contributing to the increase in the code coverage among the levels of the selected factor and the combination of another factor with the level of this factor are included as the test target. Alternatively, the additional test case generation part 140 may identify the factor for executing unexecuted paths and the level of that factor on the basis of the code coverage information 122 indicating which of the paths in the source code 11 have been executed, and generate an additional test case 141 that includes the identified factor and its level as the test target.

As another alternative, the additional test case generation part 140 may generate the additional test case 141 by using a trained model. For example, the additional test case generation part 140 may machine-train the model of which the input values are factors and levels and the output values are code coverage. For example, the trained model is created on the basis of the algorithms of neural network, decision tree, random forest, and support vector machine (SVM).

When the additional test case 141 is generated by the additional test case generation part 140, the test execution part 120 executes testing of the generated additional test case 141 and thereby generates the test result information 121 and the code coverage information 122. The test result display part 130 displays details of the result of testing of the additional test case 141.

The additional test case generation part 140 may further generate an additional test case 141 by using the additional test case 141 and the code coverage information 122 generated with respect to that additional test case 141. Generation of the additional test case 141 and execution of testing of the generated additional test case 141 may be repeated until a desired code coverage is obtained. The software verification apparatus 100 may also repeat generation and execution of the additional test case 141 until a designated test execution time is reached.

As explained above, the software verification apparatus 100 of the first embodiment includes the specification covering test case generation part 110 that generates a test case 111 covering the combination of the factors extracted from the interface specification information 12 regarding the software as the test target, the test execution part 120 that tests the software by using the generated test case 111 to generate the code coverage information 122 of the software regarding the executed test case 111, and the additional test case generation part 140 that generates an additional test case 141 making the code coverage higher than the test case 111 related to the code coverage information 122, on the basis of the relation between the factors or their levels in the test case 111 and the generated code coverage information 122.

That is, the software verification apparatus 100 of the first embodiment can acquire the code coverage information 122 by using the test case 111 covering the combination of the factors in accordance with the interface specification and, based on the acquired code coverage information 122 and the factors or the levels of the test case 111, generate an additional test case 141 for increasing the code coverage. It is thus possible to automatically generate the test cases that extensively cover the specification of the software while obtaining a high code coverage.

### Second Embodiment

Explained next are a software verification apparatus and a software verification method practiced as a second embodiment of the present invention.

The configuration of the software verification apparatus 100 of the second embodiment is similar to that of the software verification apparatus 100 of the first embodiment and hence will not be discussed further. In the software verification apparatus 100 of the second embodiment, as in the first embodiment, the arithmetic device 250 loads the stored program 210 previously stored in the storage device 200 into the memory 260 for execution, thereby implementing the function of a Pairwise test case generation part 115 to be discussed later, the function of the test execution part 120, the function of the test result display part 130, and the function of a coverage learning part 150 to be discussed later. The Pairwise test case generation part 115 corresponds to the specification covering test case generation part 110, and the Pairwise test case generation part 115 and the coverage learning part 150 correspond to the additional test case generation part 140.

FIG. 6 is a view depicting an exemplary functional configuration of the software verification apparatus 100 as the second embodiment of the present invention. In this illustration, the structures having the same functions as those of the software verification apparatus 100 of the first embodiment are designated by the same reference symbols, and these structures will not be discussed further.

As depicted, the software verification apparatus 100 is configured by the Pairwise test case generation part 115, the test execution part 120, the test result display part 130, and the coverage learning part 150. As in the first embodiment, the input to the software verification apparatus 100 includes the source code 11 of the target software and the interface specification information 12.

The Pairwise test case generation part 115 generates the test case 111 by the Pairwise method with use of factor and level information obtained from the interface specification information 12 as well as the Pairwise generation parameters 151.

The Pairwise method involves generating a test case of “n” factor coverage with respect to a designated coverage degree “n.” The “n” factor coverage means that, in a group of generated test cases, testing is carried out at least once on each of the levels specific to “n” factors included in any combination of “n” factors of the verification target. For example, one-factor coverage means that, given a group of test cases to be executed, the level of each of the factors of the test target is tested at least once. Likewise, two-factor coverage means that, given a group of test cases to be executed, each of the levels specific to two factors included in the combination of two factors of the verification target is tested at least once.

The coverage degree “n” of the Pairwise method makes it possible to designate a common “n” for all factors or to designate a different coverage degree for each of the factors, to increase or lower the coverage degree where a specific factor is included. One specific means for generating test cases by the Pairwise method may be utilization of the technique disclosed in Japanese Patent No. 2882687. For example, the Pairwise test case generation part 115 may enumerate test cases for each of the relations between factors and combine these test cases regarding the different relations into a single test case.

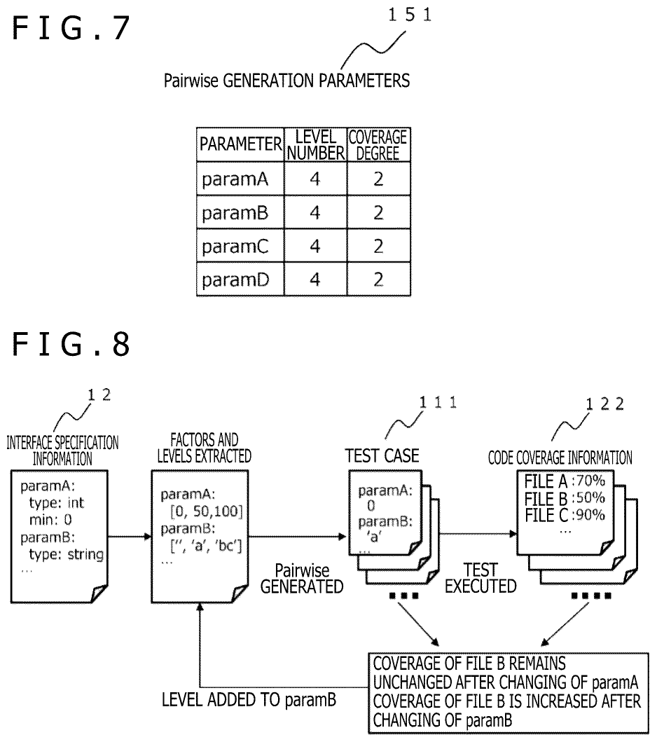

FIG. 7 is a view listing exemplary Pairwise generation parameters 151. The Pairwise generation parameters 151 each include information regarding the coverage degree and level number of each factor. In the exemplary Pairwise generation parameters 151 in the illustration, a level number “4” and a coverage degree “2” are set for each of the parameters representing factors (ParamA, ParamB, ParamC, and ParamD).

In setting the initial values of the Pairwise generation parameters 151, in addition to the method of setting in advance predetermined coverage degrees and level numbers for all factors, a method by which the user designates the coverage degrees and level numbers individually may also be used.

On the basis of the relation between a given test case 111 and the code coverage information 122 obtained by use of that test case 111, the coverage learning part 150 updates the values of the Pairwise generation parameters 151 in a manner making the code coverage higher than the test case 111 related to the code coverage information 122. Detailed processing by the coverage learning part 150 will be discussed later.

When the Pairwise generation parameters 151 are updated, the Pairwise test case generation part 115 adds a test case 111 reflecting the updated Pairwise generation parameters 151. The test execution part 120 executes testing of the added test case 111 to generate the test result information 121 and the code coverage information 122.

By use of the added test case 111 and the code coverage information 122 regarding the added test case 111, the coverage learning part 150 may further update the Pairwise generation parameters 151. Addition of the test case 111, testing of the additional test case 111, and updating of the Pairwise generation parameters 151 may be repeated until the desired code coverage is obtained. The software verification apparatus 100 may also repeat addition and execution of the test case 111 until the designated test execution time is reached.

### Outline of the Processing

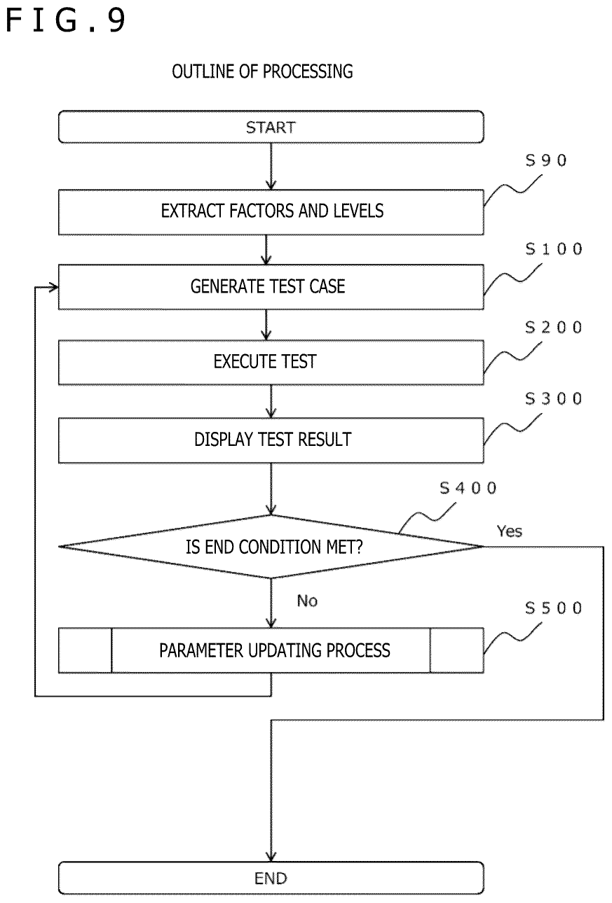

FIGS. 8 and 9 are views explaining an overall flow of processing performed by the software verification apparatus 100. For example, the software verification apparatus 100 starts the processing illustrated in the figures, when the user makes a predetermined input to the software verification apparatus 100, or at predetermined timings (e. g., at a predetermined point in time or at predetermined time intervals). The software verification apparatus 100 may start the processing illustrated in the figures, when, for example, the user designates the source code 11 of the target software and the interface specification information 12 and causes the software verification apparatus 100 to read what is designated.

First, the Pairwise test case generation part 115 of the software verification apparatus 100 extracts from the interface specification information 12 the factors to be tested and each of levels specific to these factors (S90 in FIG. 9). In the example in FIG. 8, the Pairwise test case generation part 115 extracts from the interface specification information 12 factors “paramA” and “paramB,” levels “0,” “50,” and “100” specific to the factor “paramA,” and levels “‘’,” “‘a’, ” and “‘bc’” specific to the factor “paramB.”

Next, the Pairwise test case generation part 115 generates by the Pairwise method the test case 111 that covers the factors, with use of the Pairwise generation parameters 151 (S100 in FIG. 9). In the example in FIG. 8, the test case 111 includes one in which the level “0” is set for the factor “paramA” and the level “‘a’” is set for the factor “paramB.”

The test execution part 120 then executes testing of the generated test case 111 to generate the test result information 121 and the code coverage information 122 (S200 in FIG. 9). In the example in FIG. 8, the code coverage information 122 indicates that the code coverage of file A is “70%,” the code coverage of file B is “50%,” and the code coverage of file C is “90%.”

The test result display part 130 then displays, on the screen, information indicating the result of the test execution including the generated test result information 121 and code coverage information 122 (S300 in FIG. 9).

The coverage learning part 150 then determines whether a test end condition is met (S400 in FIG. 9). For example, the coverage learning part 150 may determine that the end condition is met when the code coverage of all files or all functions is equal to or higher than a predetermined threshold (e.g., 60%) in reference to the code coverage information 122. The threshold for comparison with the code coverage is set in advance by the user. Alternatively, the coverage learning part 150 may determine that the end condition is met when a predetermined test execution time has elapsed since the testing was initiated. The test execution time is set in advance by the user. As another alternative, the coverage learning part 150 may determine that the end condition is met when the number of times the Pairwise generation parameters 151 have been updated is equal to or larger than a predetermined threshold. The threshold for comparison with the update count is set in advance by the user. As a further alternative, the coverage learning part 150 may determine that the end condition is met upon receipt of a predetermined input from the user.

When it is determined that the end condition is not met (S400 in FIG. 9: No), the coverage learning part 150 performs a parameter updating process (S500 in FIG. 9) that updates the values of the Pairwise generation parameters 151 in a manner increasing the code coverage by use of the relation between the test case 111 and the code coverage information 122 obtained using that test case 111. In the example in FIG. 8, when changing the level of the factor “paramA” does not change the code coverage of file B having a low code coverage while changing the level of the factor “paramB” increases the code coverage of file B, the coverage learning part 150 adds a level to the factor “paramB” in the Pairwise generation parameters 151. Thereafter, the software verification apparatus 100 returns to the processing of S100 in FIG. 9.

On the other hand, when the coverage learning part 150 determines that the end condition is met (S400 in FIG. 9: Yes), this process is terminated.

When the values of the Pairwise generation parameters 151 are updated as explained above, the code coverage is increased through the testing.

What follows is an explanation in detail of the parameter updating process performed by the coverage learning part 150.

### First Parameter Updating Process

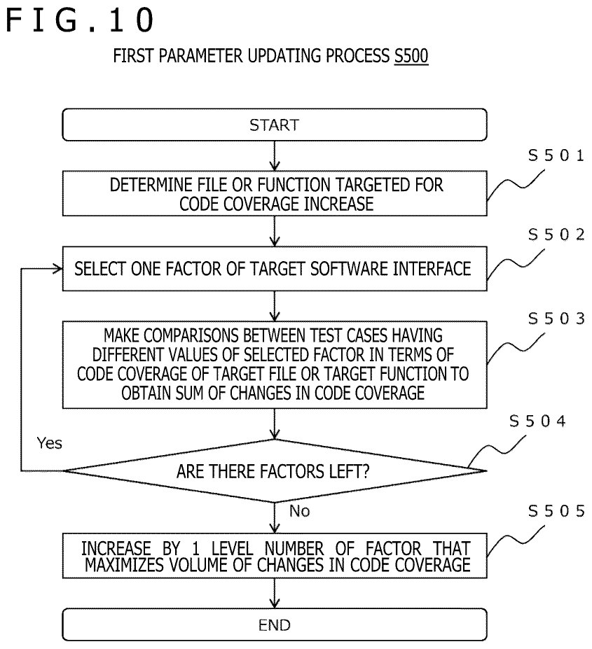

FIG. 10 is a process flowchart explaining an exemplary parameter updating process S500 performed by the coverage learning part 150. The exemplary process in this figure is performed by a method in which the values of the level numbers in the Pairwise generation parameters 151 are updated using the test case 111 and the code coverage information 122. In this example, the coverage learning part 150 generates an additional test case 141 by identifying one or multiple factors contributing to an increase in code coverage and by increasing the types of the levels for the identified factors.

First, the coverage learning part 150 determines (S501) the file or the function for which the code coverage is to be increased (referred to as a “target file or target function” hereunder). One exemplary method of determining the target file or the target function involves designation of the file or the function by the user such as developers or testers. Another exemplary method involves automatically selecting and determining the file or the function that fails to meet a predetermined code coverage criterion.

Next, the coverage learning part 150 selects one factor extracted from the interface specification information 12 (S502).

The coverage learning part 150 then makes comparisons between the test cases in which different levels are set regarding the selected factor, in terms of changes (differences) in the code coverage of the target file or the target function. The coverage learning part 150 calculates the sum of the changes in the code coverage for the combinations of all test cases in which different levels are set (S503).

The coverage learning part 150 then determines (S504) whether there are any factors left for which the changes in the code coverage have yet to be calculated (i.e., factors on which the processing of S503 has not been performed yet).

When there are such factors left (S504: Yes), the coverage learning part 150 selects another remaining factor to calculate the volume of changes in the code coverage for that factor, and repeats the processing of S502 and S503.

On the other hand, when there is no factor left (i.e., when the volumes of changes in the code coverage of all factors have been calculated) (S504: No), the coverage learning part 150 selects the factor that maximizes the calculated sum of changes in the code coverage for each of the factors, and increases by 1 the level number for the selected factor in the Pairwise generation parameters 151 (S505). Thereafter, the coverage learning part 150 terminates the first parameter updating process.

Given the factor which, when its value is changed, entails a large change in the code coverage of the target file or target function, there may be added a test case in which that factor is given a new level in expectation of an increase in percentage of the code coverage because there occurs a new code coverage different from the existing code coverage. In the first parameter updating process, the coverage learning part 150 thus increases the level number of the factor that maximizes the volume of changes in the code coverage, and generates a test case in which the new level is set, in order to efficiently increase the code coverage.

In the above-described exemplary process, the coverage learning part 150 selects one factor for which the level number is to be increased. Alternatively, there may be multiple factors for which the level number is to be increased. For example, the coverage learning part 150 may increase the level number for a predetermined number of factors in descending order of the volume of their changes in the code coverage. As another alternative, the coverage learning part 150 may increase the level number for all factors having at least a predetermined volume of changes in the code coverage. The value by which to increase the level number is not limited to 1 and may be 2 or larger.

### Second Parameter Updating Process

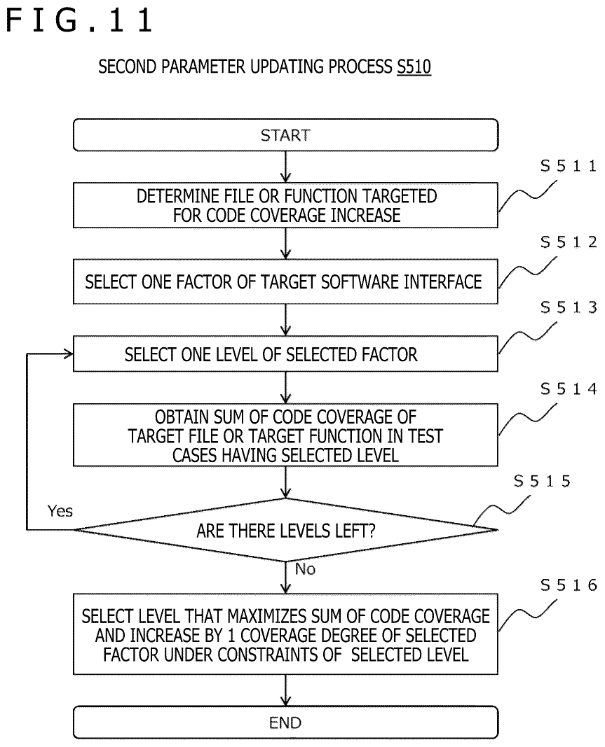

FIG. 11 is a process flowchart explaining another exemplary parameter updating process S510 performed by the coverage learning part 150. This flowchart gives an exemplary process different from the first parameter updating process in FIG. 10. The exemplary process in this figure is performed by a method in which the test case 111 and the code coverage information 122 are used to update the values of the coverage degrees in the Pairwise generation parameters 151. In this example, the coverage learning part 150 identifies the level of the selected factor on which the code coverage is larger than on the other levels, and generates an additional test case that includes, as the test target, the combination of the selected factor and the identified level and the combinations of the other factors and their levels.

First, the coverage learning part 150 determines the target file or target function for which the code coverage is to be increased (S511). The method of determining the target file or target function is similar to that in S501 explained above and will hence not be discussed further.

Next, the coverage learning part 150 selects one of the factors defined in the interface specification information 12 (S512). One exemplary method of selecting the factor is by designation by the user such as developers or testers. Another exemplary method is similar to that of the first parameter updating process in which the factor targeted for level update is selected. Another alternative method is random selection.

The coverage learning part 150 then selects one level specific to the selected factor (S513).

The coverage learning part 150 calculates the sum of the code coverage of the target file or target function in the test cases in which the selected level is set (S514).

The coverage learning part 150 then determines (S515) whether the selected factor has other levels left for which the sum of the code coverage has yet to be calculated (i.e., levels on which the processing of S514 has not been performed yet).

When there are other levels left (S515: Yes), the coverage learning part 150 selects another remaining level to calculate the sum of the coverage on that level, and repeats the processing of S513 and S514.

On the other hand, when there is no level left (i.e., when the sum of the code coverage on all levels of the selected factor has been calculated) (S515: No), the coverage learning part 150 selects the level on which the sum of the code coverage calculated for all levels is maximized. The coverage learning part 150 then increases by 1 the coverage degree in the Pairwise generation parameters 151 for the factors having the selected level, under the constraint of the selected level being used for reference (S516). Thereafter, the coverage learning part 150 terminates the second parameter updating process.

Given source code that changes the function to be called depending on the value of a given factor and given that a specific value is set for that factor, there are many cases where the code coverage of the called function remains unchanged even if the values of the other functions are changed. Meanwhile, given a level on which the code coverage is relatively large in the existing test cases, keeping that level unchanged while changing the values of the other factors can expect to increase the code coverage. In the second parameter updating process, the coverage learning part 150 thus fixes the level on which the sum of the code coverage is maximized and raises the coverage degree, thereby adding a test case having that level for efficient code coverage increase.

In the above-described exemplary processing, the coverage learning part 150 increases the coverage degree of the factor having the level on which the sum of the code coverage is maximized. Alternatively, the coverage learning part 150 may increase the coverage degree of multiple factors (e.g., all factors) under the constraint of fixing the level on which the sum of the code coverage is maximized. The value by which to increase the coverage degree is not limited to 1 and may be 2 or larger.

The first parameter updating process in FIG. 10 and the second parameter updating process in FIG. 11 are only examples of the processing performed by the coverage learning part 150 and are not limitative of the type of processing executed by the coverage learning part 150. For example, the processing by the coverage learning part 150 may include both the first parameter updating process and the second parameter updating process.

In carrying out the processing, the coverage learning part 150 may determine the parameters to be updated, by using machine learning algorithms including random forest, deep neural network, and support vector machine.

### Test Result Display Screen

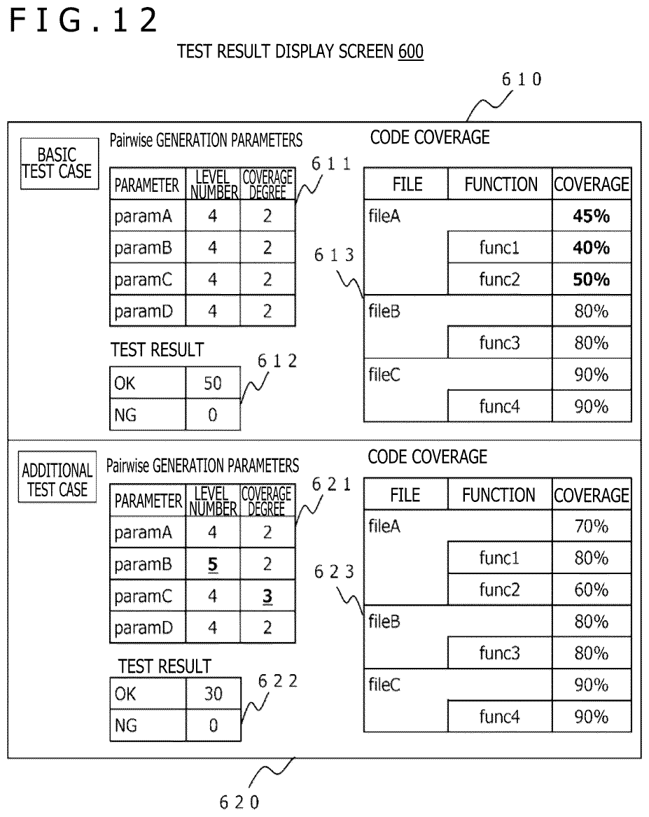

FIG. 12 is a view depicting an exemplary test result display screen 600 generated by the test result display part 130. The display example in this figure indicates the result of a case where the level number of 4 and the coverage degree of 2 are designated for all factors as the initial Pairwise generation parameters 151 for the software having an interface of four factors (paramA through paramD).

The test result display screen 600 includes a basic test case result display region 610 and an additional test case result display region 620.

The basic test case result display region 610 is a region that displays the result of testing a basic test case generated by the Pairwise method with use of initial Pairwise generation parameters 151. As illustrated, the basic test case result display region 610 includes a parameter display region 611, a test result display region 612, and a code coverage display region 613.

The parameter display region 611 is a region that displays the level number and coverage degree of each of the factors (parameters) of the initial Pairwise generation parameters 151. In this display example, the level number is “4” and the coverage degree is “2” for all factors.

The test result display region 612 is a region that displays the number of successful test cases (OK) and the number of failed test cases (NG) resulting from testing each of the basic test cases. In this display example, the test result display region 612 indicates that 50 basic test cases have been generated and that all the test cases have been successful.

The code coverage display region 613 is a region that displays the code coverage (in percentage) for each of the files and each of the functions constituting the source code 11 of the target software. In this display example, the code coverage is targeted for 60%. The test result display part 130 causes the code coverage display region 613 to highlight in bold letters the code coverage of the files and functions that fail to meet the code coverage target. This allows the user to easily recognize the files or the functions of which the code coverage fails to meet the target.

Also in this example, the coverage learning part 150 automatically selects any file or function failing to meet the code coverage target as the target file or the target function for code coverage increase. When the user is prompted to select the target file or the target function for code coverage increase, the coverage learning part 150 may receive from the user a selective input of the target file or the target function through the test result display screen 600.

The additional test case result display region 620 is a region that displays the result of testing an additional test case generated anew by the Pairwise method with use of the Pairwise generation parameters 151 updated by the coverage learning part 150. As indicated, the additional test case result display region 620 includes an updated parameter display region 621, an additional test result display region 622, and an updated code coverage display region 623.

The updated parameter display region 621 is a region that displays the level number and coverage degree of each of the factors (parameters) of the updated Pairwise generation parameters 151. The test result display part 130 causes any level number or coverage degree changed from those of the initial Pairwise generation parameters 151 to be indicated in underlined bold letters. This allows the user to easily recognize the values of the updated Pairwise generation parameters 151. In this example, the updated parameter display region 621 indicates that the level number of the factor “paramB” is increased from “4” to “5” and that the coverage degree of the factor “paramC” is raised from “2” to “3.”

The additional test result display region 622 is a region that displays the number of successful test cases (OK) and the number of failed test cases (NG) resulting from testing each of the additional test cases. In this display example, the additional test result display region 622 indicates that 30 additional test cases have been generated and that all the additional test cases have been successful.

The updated code coverage display region 623 is a region that displays the code coverage for each of the files and functions constituting the source code 11 of the target software, with the basic and additional test cases combined. In this display example, the updated code coverage display region 623 indicates that the code coverage percentages for the file “fileA” and for the functions therein are increased by the additional test cases, amounting to the code coverage of at least 60%.

The information displayed on the test result display screen 600 is not limited to what has been discussed above. For example, the information may include code coverage information in units of lines indicating whether each of the lines of a given function has been executed by a given test case.

Besides being displayed on the screen or printed as reports on sheets of paper by the input/output device 270, the information included in the test result display screen 600 may alternatively be sent by email via networks to such user as developers.

The manner of highlighting the items on the test result display screen 600 is not limited to what has been explained above. Alternatively, the test result display part 130 may highlight the items by changing the background color or the text color.

As explained above, from the interface specification information 12, the software verification apparatus 100 embodying the present invention extracts each of the factors and the levels specific thereto of the software. The software verification apparatus 100 then generates a test case 111 for a factor-covering test in which each of the factors and the levels specific thereto in the combinations of the extracted factors is tested at least one.

The above configuration permits automatic generation of the test case 111 efficiently covering the combinations of possible values in the combinations of multiple factors.

The software verification apparatus 100 embodying the present invention generates an additional test case by identifying the factor or level contributing to increasing the code coverage, on the basis of the generated code coverage information 122.

The configuration above generates the additional test case based on the factor or the level contributing to code coverage increase. It is thus possible to generate more efficiently the additional test case for increasing the code coverage.

Also, the software verification apparatus 100 embodying the present invention identifies one or multiple factors contributing to increasing the code coverage, and generates the additional test case by increasing the types of the levels specific to the identified factors.

As described above, adding a test case in which a new level is set regarding the factor contributing to code coverage increase can expect to increase the code coverage. It is thus possible to generate more efficiently the additional test case for increasing the code coverage, by increasing the types of the levels specific to the factors contributing to code coverage increase.

Also, the software verification apparatus 100 embodying the present invention selects the target file or target function for code coverage increase and, between test cases 111 in which different levels are set, identifies the factor of which the volume of changes in the code coverage is larger than the other factors with respect to the selected target, the identified factor being a factor contributing to increasing the code coverage.

The above-described configuration identifies more accurately the factors contributing to increasing the code coverage of the target file or target function. This makes it possible to efficiently generate the additional test case for increasing the code coverage of the target file or target function.

Also, the software verification apparatus 100 embodying the present invention identifies the level of the selected factor on which the code coverage is higher than on the other levels, and generates an additional test case that includes as the test target the combination of the selected factor and the identified level and the combinations and their levels.

As descried above, given the level on which the code coverage is relatively high, changing the values of the other factors while keeping that level unchanged can expect to increase the code coverage. Thus, generating an additional test case including the level on which the code coverage is high leads to more efficient generation of the additional test case for increasing the code coverage.

Also, the software verification apparatus 100 embodying the present invention selects the target file or target function for code coverage increase, identifies the level on which the code coverage is higher than on the other levels in the selected target, and generates an additional test case that includes as the test target the combination of the selected factor and the identified level and the combinations of the other factors and their levels.

The above configuration identifies more accurately the level contributing to increasing the code coverage of the target file or target function. This makes it possible to efficiently generate the additional test case that increases the code coverage of the target file or target function.

The embodiments of the present invention are not limited to those discussed above. The invention may be practiced using any suitable components within the scope and spirit thereof. The embodiments and their variations explained above are only examples, and their specifics do not limit the present invention as long as they do not impair the advantages of the invention. The embodiments and variations discussed above are not limitative of the present invention. Other modes of embodying the invention conceivable within the technical scope thereof also fall within the scope of the present invention.

For example, a portion of the hardware belonging to each of the devices in the above embodiments may be placed in other devices.

Each program in the software verification apparatus may be placed in some other apparatus. One program may be configured by multiple programs, and multiple programs may be integrated into a single program.

### DESCRIPTION OF REFERENCE SYMBOLS

11: Source Code
12: Interface specification information
100: Software verification apparatus
110: Specification covering test case generation part
111: Test case
115: Pairwise test case generation part
120: Test execution part
121: Test result information
122: Code coverage information
130: Test result display part
140: Additional test case generation part
141: Additional test case
150: Coverage learning part
151: Pairwise generation parameter
200: Storage device
210: Program
250: Arithmetic device
260: Memory
270: Input/output device
600: Test result display screen

1. A software verification apparatus comprising:
a processor;
a memory;
a specification covering test case generation part configured to generate a test case that covers a combination of factors extracted from specification information regarding software given as a test target;
a test execution part configured to execute testing of the software by using the generated test case to generate code coverage information regarding the software in the executed test case; and
an additional test case generation part configured to, based on a relation between a corresponding one of the factors or a level thereof in the test case generated by the specification covering test case generation part and the generated code coverage information, generate an additional test case that makes a code coverage higher than the test case related to the code coverage information.

2. The software verification apparatus according to claim 1, wherein the specification covering test case generation part extracts from the specification information each of the factors of the software and a level specific to each of the factors, and generates a test case for which the testing is executed at least once on each of the levels specific to the factors included in a combination of the extracted factors.

3. The software verification apparatus according to claim 2, wherein the additional test case generation part generates the additional test case by identifying the factor or the level contributing to increasing the code coverage, on a basis of the generated code coverage information.

4. The software verification apparatus according to claim 3, wherein the additional test case generation part generates the additional test case by identifying one or multiple factors contributing to increasing the code coverage and by increasing types of levels specific to the identified factor.

5. The software verification apparatus according to claim 4, wherein the additional test case generation part selects a target file or a target function for which the code coverage is to be increased and, between the test cases in which different levels are set, identifies the factor of which volume of changes in the code coverage is larger than other factors with respect to the selected target, as the factor contributing to increasing the code coverage.

6. The software verification apparatus according to claim 3, wherein the additional test case generation part identifies the level on which the code coverage is higher than on other levels of the selected factor, and generates an additional test case that includes as the test target a combination of the selected factor and the identified level and combinations of other factors and the levels thereof.

7. The software verification apparatus according to claim 6, wherein the additional test case generation part selects a target file or a target function for which the code coverage is to be increased, identifies the level on which the code coverage is higher than on other levels of the selected target, and generates an additional test case that includes as the test target the combination of the selected factor and the identified level and the combinations of the other factors and the levels thereof.

8. A software verification method for causing an image processing apparatus to perform:
a specification covering test case generation process that generates a test case that covers a combination of factors extracted from specification information regarding software given as a test target;
a test execution process that executes testing of the software by using the generated test case to generate code coverage information regarding the software in the executed test case; and
based on a relation between a corresponding one of the factors or a level thereof in the generated test case and the generated code coverage information, an additional test case generation process that generates an additional test case that makes a code coverage higher than the test case related to the code coverage information.

9. The software verification method according to claim 8, wherein, in the specification covering test case generation process, the information processing apparatus is caused to extract from the specification information each of the factors of the software and a level specific to each of the factors, and generate a test case for which the testing is executed at least once on each of the levels specific to the factors included in a combination of the extracted factors.

10. The software verification method according to claim 9, wherein, in the additional test case generation process, the information processing apparatus is caused to generate the additional test case by identifying the factor or the level contributing to increasing the code coverage, on a basis of the generated code coverage information.

11. The software verification method according to claim 10, wherein, in the additional test case generation process, the information processing apparatus is caused to generate the additional test case by identifying one or multiple factors contributing to increasing the code coverage and by increasing types of levels specific to the identified factor.

12. The software verification method according to claim 11, wherein, in the additional test case generation process, the information processing apparatus is caused to select a target file or a target function for which the code coverage is to be increased and, between the test cases in which different levels are set, identify the factor of which volume of changes in the code coverage is larger than other factors with respect to the selected target, as the factor contributing to increasing the code coverage.

13. The software verification method according to claim 10, wherein, in the additional test case generation process, the information processing apparatus is caused to identify the level on which the code coverage is higher than that on the other levels of the selected factor, and generate an additional test case that includes as the test target a combination of the selected factor and the identified level and combinations of other factors and the levels thereof.

14. The software verification method according to claim 13, wherein, in the additional test case generation process, the information processing apparatus is caused to select a target file or a target function for which the code coverage is to be increased, identify the level on which the code coverage is higher than on other levels of the selected target, and generate an additional test case that includes as the test target a combination of the selected factor and the identified level and combinations of other factors and the levels thereof.
